(19) United States
(12) Patent Application Publication
(10) Pub. No.: US 2007/0170287 A1
(43) Pub. Date: Jul. 26, 2007

(54) Solenoid stator

(76) Inventor: Anh Ngoc Pham, Pepper Pike, OH (US)

Correspondence Address: PEARNE & GORDON LLP, 1801 EAST 9TH STREET, SUITE 1200, CLEVELAND, OH, 44114-3108, US

(21) Appl. No.: 11/332,942

(22) Filed: Jan. 17, 2006

(51) Int. Cl. F02M 47/02; H01F 7/08; H01F 7/00

(52) U.S. Cl. 239/585.1; 335/260; 239/88; 335/278

(57) ABSTRACT

A stator assembly for an electronically controlled unit-type fuel injector comprising a stack of electrical steel laminations, an electrical coil assembled around the laminations, a pair of terminals terminating the ends of the coil, and an insulating housing body, the laminations having spaced pole faces, the housing body being a settable resin injection molded around the coil, portions of the terminals, and substantially all of the lamination stack but for the lamination stack pole faces at a plane at a side of the housing, the laminations being stamped using a punch and die, the punch sides of the laminations all being oriented in the same direction, determined by registering a minor, deliberate asymmetry in the lamination profile, whereby each lamination is nested in the edge burrs and/or concavity of an adjacent lamination.

### BACKGROUND OF THE INVENTION

The invention relates to improvements in electronic fuel injector assemblies and, in particular, to an improved electrical stator for solenoid control of the fuel injection timing.

### PRIOR ART

It is known to control the timing of injection of fuel into the combustion chamber of a diesel engine by regularly “spilling” fuel being mechanically displaced by a pump plunger until injection is to be initiated. When injection is to occur, the fuel spillage path is blocked by operating a solenoid. The solenoid exists in a relatively hostile environment where it is subjected to extremes of temperature, vibration, and circulating fuel pump pressure. These conditions produce stresses on the solenoid stator that can promote cracks in the stator insulation housing. Such cracks can permit fuel leakage outside of the fuel injector and to the environment.

### SUMMARY OF THE INVENTION

The invention provides an improved stator assembly in an electronic fuel injector. The stator assembly comprises a stack of electrical steel laminations, a wire coil surrounding the laminations, and a molded insulating housing encasing the lamination stack. The lamination stack of the invention has a unique arrangement that enables it to be built up with a uniform, essentially void-free construction. This uniform, void-free lamination stack prevents the housing material, when it is being injected, from being forced between laminations. By avoiding even small spaces or gaps between adjacent laminations, the stack excludes insulating material from finding its way into the interior of the stack. A condition in which harmful cracks might occur in the housing body could otherwise exist where insulating material is forced by injection pressures into any voids or crevices in the lamination stack. The existence of flash-like formations of insulating material between laminations can give rise to local stress riser conditions from which cracks may originate. Minute cracks occurring in the interior of the insulating body can propagate to the exterior of the body. An external crack creates a. path for leakage of fuel out of the fuel injector. External fuel leakage requires the removal and replacement of the solenoid stator assembly.

The invention, in addition to reducing the risk for cracks to develop in the body of the insulation, can offer potential improvements in the performance of the solenoid. The avoidance of air gaps in the lamination stack can produce a stronger magnetic attraction force and greater uniformity or consistency in the performance among solenoids of the same design. Improved performance and consistency of the solenoid assembly can permit greater accuracy in fuel injection timing and, consequently, engine power and/or efficiency.

An essentially void-free stack of laminations is produced, according to the invention, by orienting the punch side (and therefore the die side) of all of the laminations in the same direction. This can be accomplished by making the main area of the lamination profile, for the most part, symmetrical about a center line, while creating a local and relatively small area non-symmetrical with the corresponding area on the opposite side of the center line. The non-symmetrical area enables the profile to be readily oriented so that punch sides of the laminations can be consistently aligned to the same direction. The proper orientation of the laminations can be readily accomplished manually or by a suitable automated process. By aligning the laminations, any burrs or cupping of the laminations are oriented in the same direction so that the laminations can nest in one another. This nesting avoids air pockets that could otherwise occur where burrs, concave faces, or convex faces of abutting laminations are in contact.

### BRIEF DESCRIPTION OF THE DRAWINGS

FIG. 1 is a side view, primarily in section, of an electronically controlled fuel injector;

FIG. 2 is an enlarged view of a portion of the fuel injector in cross-section and a solenoid stator assembly thereof in elevation;

FIG. 3 is a cross-sectional view of the stator assembly on still a larger scale; and

FIG. 4 is a cross-sectional view of the stator assembly in plane perpendicular to the plane of FIG. 3.

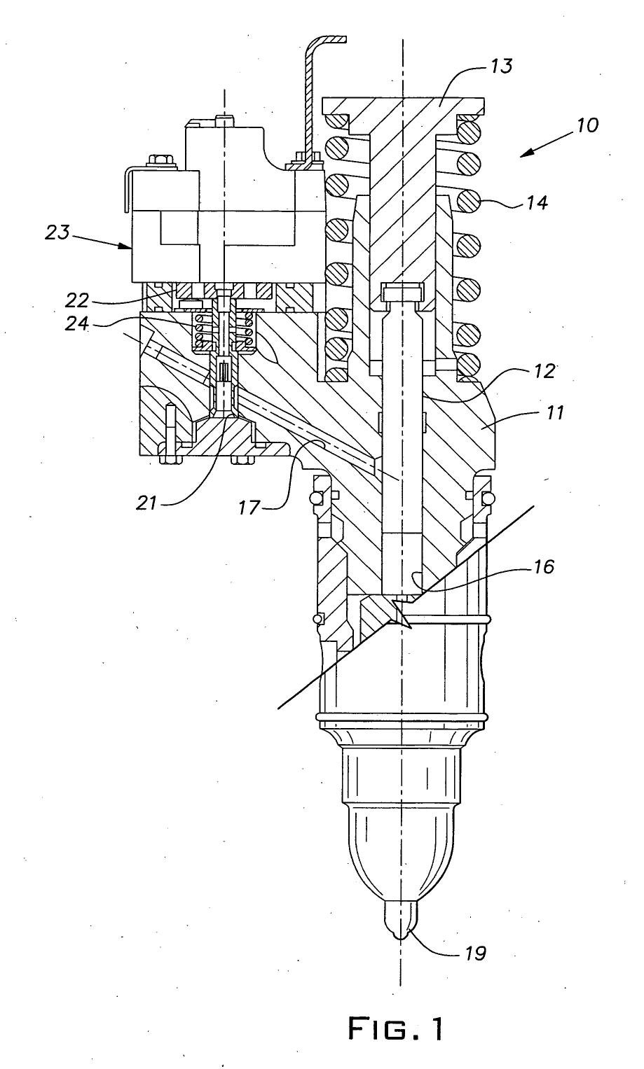

### DESCRIPTION OF THE PREFERRED EMBODIMENT

A unit type fuel injector 10 for operating a diesel engine has a generally known construction disclosed, for example, in U.S. Pat. No. 4,568,021. The injector 10 includes a body 11 in which a pump plunger 12 is disposed. The pump plunger 12 is reciprocated in the body 11 by a follower 13. The follower 13 and pump plunger 12 connected to it are reciprocated by a cam (not shown) of the engine and a return spring 14. The plunger 12 displaces fuel from a chamber 16 through a passage 17 and a spill chamber 18 forming a pilot circuit. When the plunger 12 is descending and flow to the spill chamber 18 is blocked, a high injection pressure is developed in the pump chamber 16. The injection pressure overcomes the spring force closing a needle valve (not shown) and fuel is injected into the associated engine cylinder through the injector tip 19.

Fuel is blocked from exhausting to the spill chamber 18 by axial displacement of a valve member 21 against a seat 20. The valve member 21 is selectively operated to precisely control the timing and duration of fuel injection. A ferromagnetic armature plate 22 is fastened to the valve member 21. The plate 22 and valve member 21 form an armature that is magnetically drawn towards poles 27, 28 of a solenoid stator assembly 23 against the bias of a return spring 24 when a coil 26 of the assembly is electrically energized to close the valve against the seat 20. When the coil 26 is de-energized, the valve 21 is opened by the spring 24.

The stator assembly 23 principally comprises a stack 31 of identical laminations 36, the coil 26 of wire disposed around the laminations, and an electrically insulating housing 33 molded around the laminations and coil. The laminations 36 of the stack 31 are preferably manufactured by stamping with a punch and die set as is conventional. The illustrated laminations 36 are preferably formed of electrical steel lightly coated with electrical insulating material and have an E-shaped profile. With reference to FIG. 3, the profile of each lamination 36 on a large or macroscopic scale is symmetrical about an imaginary line 37 in the middle of a central leg 38. Distal portions of the central leg 38 and two outward legs 39 and a center of a bridge 41 between the legs each have a circular hole 42 for receiving a steel rivet 43. In assembly, the rivets 43 hold the laminations 36 together in tight abutting engagement. The central leg 38 is somewhat larger in width than the outward legs 39 to compensate for the presence of its rivet 43 and maintain adequate magnetic flux path characteristics.

Inspection of the profile of a lamination 36, shown in FIG. 3, reveals that a deliberate minor difference between the right and left side of the profile exists. This difference takes the form of a large radius on a left-outside corner 44 between the bridge 41 and left leg 39 as compared to a relatively smaller outside radius on a corresponding right-hand corner 46. The small but discernable difference between the left and right corner portions 44, 46 is insignificant in effect on the magnetic circuit and function developed by the stator assembly 23. The difference between the left and right corners 44, 46 of the lamination profile is, however, sufficient to enable a human observer by sight or feel and/or an inanimate discriminating device using mechanical, electrical, or optical sensing to differentiate the left side of the lamination 36 from the right side.

Typically, the laminations 36 are stamped at high speed from sheet stock fed into a punch and die set operating in a punch press. The blanked out laminations 36 are collected in a hopper without regard to maintaining their orientation on any axis. Ordinarily, a stamping will exhibit burrs at its sheared edges, albeit nearly microscopic when the tooling is properly made and well maintained. The burrs will extend at the punch side away from the die side of the lamination 36. Additionally, a stamped lamination may exhibit slight cupping so that it is also concave on the punch side.

A person or machine can assemble a stack 31 of laminations 36 so that owing to the minor and magnetically insignificant asymmetry afforded by the difference in radius at the corners 44, 46, their profiles are in registration. This assures that the punch sides of the laminations or blanks 36 are all facing in the same direction. The tendency for burrs or cupping of these laminations to produce gaps or air spaces is effectively eliminated by nesting that results from being aligned in the same direction.

The coil 26 of electrical wire is wound on a spool 48 and the spool with the coil is assembled around the middle lamination leg 38. The leads or ends (not shown) of the coil 26 are soldered or otherwise electrically connected to electrical terminals 49. Before molding of the housing 33, the terminals 49 are provisionally held in place on the lamination stack 31 by an electrically insulating holder 51.

The lamination stack or assembly 31, coil 26 on the spool 48, and terminals 49 on the holder 51 are disposed in a mold cavity (not shown) and a settable insulating resin material is injected into the mold to form the housing 33. The insulating material preferably comprises a thermoset resin such as a commercially available phenolic with a suitable commercially available filler. The phenolic or other resin filler ideally is of the type that is chemically unaffected by diesel fuel.

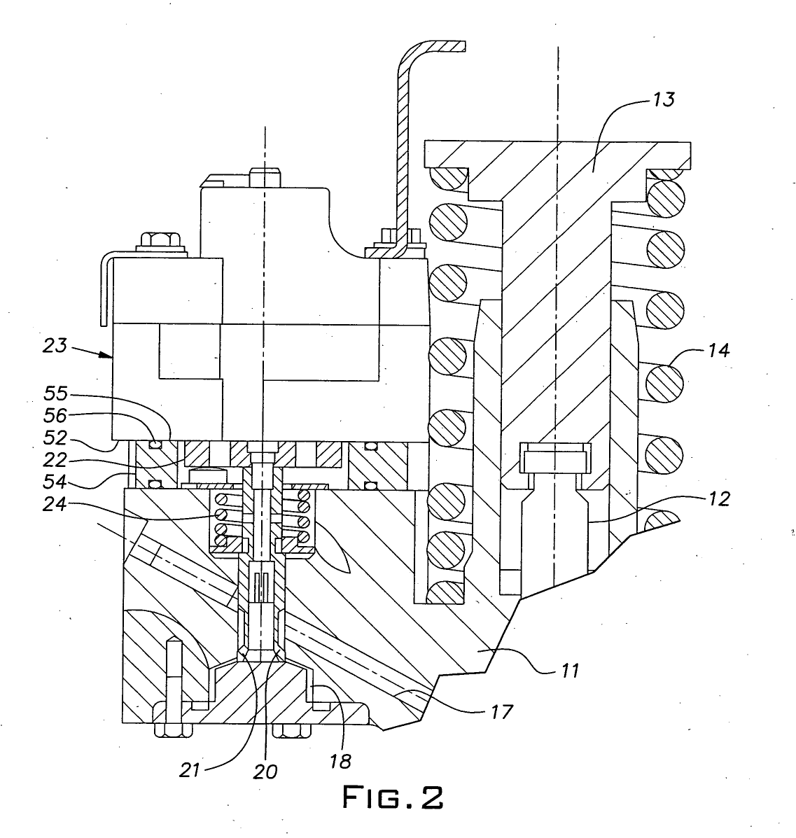

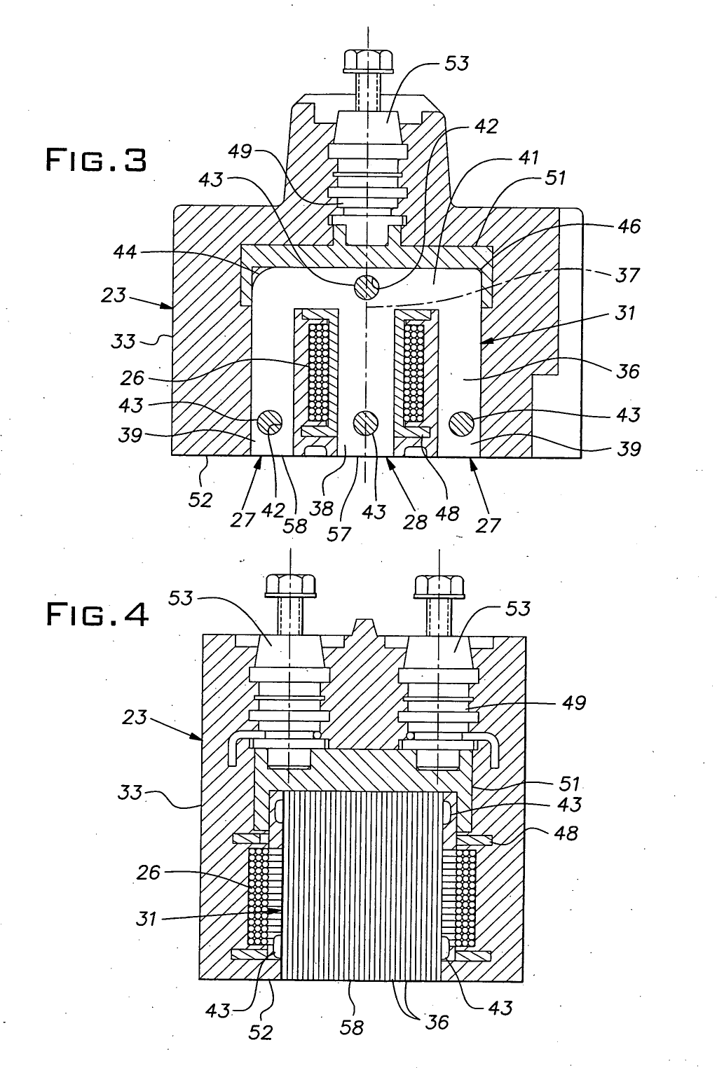

As shown in FIGS. 3 and 4, the insulating housing 33 completely envelopes the lamination stack 31, spool 48, and coil 26, terminal holder 51, and terminals 49, except for portions of the lamination stack at a lower face 52 of the stator assembly 23 and upper projecting portions 53 of the terminals 49. The lower face 52 of the stator assembly 23 formed by the legs 38, 39 and surrounding material of the insulating housing body 33 can be machined or ground to ensure that it is relatively flat. The common flat or planar surface 52 of the lamination legs 38, 39 and housing body 33 enables the stator assembly 23 to be reliably sealed with an O-ring 56. Faces 57, 58 of the legs 38, 39 at the face 52 constitute the pole faces of the stator assembly 23. The O-ring 56 has a circular cross-section shown in FIG. 2 and a rectangular shape when viewed in a plane parallel to the stator assembly face 52. The O-ring 56 is received in a groove formed in a seat surface 55 of an adapter plate 54, carried on the main body 11, that surrounds the armature plate 22.

During operation of the engine, fuel is constantly circulated through the injector body at a low pressure of, for example, about 40 psi. Cyclic operation of the pump plunger 12 and closing of the valve 21 develops a high injection pressure at the nozzle. The stator assembly 23 is subjected to fuel circulating or supply pressure, engine vibration, ambient temperature, engine temperature and cyclic electromagnetic pulses during its service. A crack in the housing body 33 can allow fuel driven by the supply pressure to leak from the fuel injector through the housing body. The risk of a crack developing can be dependent on the extent that stress risers and irregularities are molded into the body 33. The uniform alignment of the laminations 36, as provided by the invention, allows unintended but difficult to avoid non-planar characteristics existing in the separate laminations 36 to be nested. Consequently, there are essentially no narrow spaces existing between separate laminations 36 where insulation material of the body 33 can be injected even under normally high conventional injection molding pressures. Therefore, settable insulation material has no intra-lamination space to migrate into when injected into the mold that forms the housing 33 and thereby create flash-like formations in such spaces. A flash-like thin formation of insulating material can represent an irregularity and, therefore, a stress riser in the body 33 and a source of a crack. Depending on the size and number of gaps or spaces that might otherwise occur between the laminations 36, without benefit of the invention, the performance of the solenoid assembly can be adversely affected.

It should be evident that this disclosure is by way of example and that various changes may be made by adding, modifying or eliminating details without departing from the fair scope of the teaching contained in this disclosure. For instance, the laminations 36 can be arranged with a C-shaped profile and/or the laminations can be welded together rather than being riveted. The invention is therefore not limited to particular details of this disclosure except to the extent that the following claims are necessarily so limited.

What is claimed is:

1. An electronically controlled fuel injector comprising a main body for enclosing a plunger for pressurizing fuel and a pilot fluid circuit for controlling the time and duration of fuel injection, the pilot fluid circuit including a movable armature, a stator assembly for operating the armature, the stator assembly having a planar face abutting a receiving seat on the main body, the armature being surrounded by said seat, the stator assembly comprising a stack of steel laminations in parallel planes perpendicular to said face, an electrical coil wrapped around a portion of said stack and capable when electrically energized to magnetize said lamination stack and thereby magnetically attract said armature toward said lamination stack, the laminations being stamped from sheet stock and being oriented with the face engaged by a punch and having any resulting burrs with a common orientation such that the laminations are in substantially full abutting contact by virtue of being nested within any burrs present on abutting laminations.

2. A fuel injector as set forth in claim 1, wherein said laminations are held in abutting contact with a plurality of rivets.

3. A fuel injector as set forth in claim 1, wherein said laminations have identical stamped profiles that are asymmetrical about an imaginary center line whereby uniformity of orientation of the lamination faces is assured by alignment of the profiles of the individual laminations.

4. A fuel injector as set forth in claim 3, wherein the profile of the laminations is the shape of a generally rectangular E formed by three parallel legs and a common bridge.

5. A fuel injector as set forth in claim 4, wherein the outside corner of the E profile where an outside of one of said legs merges with an end of the bridge is shaped differently than an opposed corner, the laminations all having their differently-shaped corner located at the same corner of the stack of laminations.

6. A method of making a stator solenoid for electronic fuel injectors for applications where the stator can be exposed to fuel that is pressurized comprising stamping a plurality of steel laminations with an identical profile, each lamination including at least two legs generally parallel to one another having end areas adapted to form pole faces of the stator, assembling the stamped laminations in a stack with the punch side of each of the laminations abutting the die side of an adjacent lamination so that any burrs resulting from the stamping process are aligned in the same direction and gaps between adjacent laminations are substantially eliminated, assembling an electrical coil around a lamination stack, and injection molding an electrically insulating housing around the lamination stack and coil, molding or otherwise forming the housing so that it surrounds all but the pole faces of the lamination stack formed by the collective end areas of the lamination legs, the gap free condition of the stator laminations excluding housing material from being injected into spaces between the laminations.

7. A method as set forth in claim 6, wherein said laminations are held tightly together by rivets distributed within the profile of said laminations.

8. A method as set forth in claim 7, wherein said laminations have the profile of an E.

9. A stator assembly for an electronically controlled unit-type fuel injector comprising a stack of electrical steel laminations, an electrical coil assembled around the laminations, a pair of terminals terminating the ends of the coil, and an insulating housing body, the laminations having spaced pole faces, the housing body being a settable resin injection molded around the coil, portions of the terminals, and substantially all of the lamination stack but for the lamination stack pole faces at a plane at a side of the housing, the laminations being stamped using a punch and die, the punch sides of the laminations all being oriented in the same direction whereby each lamination is nested in any edge burrs and/or concavity of an adjacent lamination.

10. A stator assembly as set forth in claim 9, the laminations being nearly symmetrical about an imaginary plane transverse to their plane and midway between said pole faces, the profile of each of the laminations being identical and having a deliberate minor magnetically insignificant asymmetry that enables the laminations to be readily oriented facewise, with respect to the side engaged by a punch, in the same direction.
